(19) United States
(12) Patent Application Publication
(10) Pub. No.: US 2003/0112119 A1
(43) Pub. Date: Jun. 19, 2003

(54) Independent teleservicing module with a pager as its means of communication

(76) Inventors: Wayne C. Hom, Rancho Santa Margarita, CA (US); Walter Parsadayan, Lake Forest, CA (US)

Correspondence Address: LEVIN & HAWES, P O BOX 4140, LAGUNA BEACH, CA, 92652

(21) Appl. No.: 10/027,600

(22) Filed: Dec. 19, 2001

(51) Int. Cl. G06F 7/00

(52) U.S. Cl. 340/5.2; 340/7.21; 340/3.43

(57) ABSTRACT

A diagnostic unit is disclosed that monitors the operational parameters of a security system and upon detection of a variation in the operational parameters beyond preset limits transmits over a wireless communication device a signal warning of a potential failure of the system. Upon receipt of the signal by a remote unit a communication link can be established and the diagnostic unit queried as to the status of various operational parameters to determine if a failure has occurred and the cause of such failure. In one form of the invention two-way wireless pagers are used as the communication devices.

### FIELD OF THE INVENTION

The present invention relates to security systems and a system and method for monitoring their operation. More particularly it relates to a system and method for detecting a system fault or failure and providing instantaneous notice of the same.

### BACKGROUND OF THE INVENTION

Security systems are in common and widespread use. Many such systems consist of security gate systems used to control access to a restricted area. Entryways into secure areas such as apartment complexes, gated communities and single-family residences that use these systems are often located in remote or isolated locations. Additionally, it is very expensive to provide a 24 hour human presence to man the entryway. Thus, many security gate systems and similar systems rely on automated unmanned systems to control access. In order to gain entry into the secure area with such automated systems, the person seeking entry, whether on foot or in a vehicle must present a valid entry code or command to the system whether it is by way of radio transmitter, transponder, gate opener, key pad or the like. A gate operator controlling the system, upon receipt of a valid entry command, will open and close the gate to allow entry into or exit from the restricted area. However, there are conditions that may impair, restrict, or prevent the gate operator from performing correctly such as external obstacles preventing the gate from moving or failures within the gate operator itself. When any of these situations occur, egress or ingress through the gate can be blocked (gate closed) or security compromised (gate open). Since the entryway is unmanned and perhaps in a remote location, the time from such occurrence of a failure of the system to someone reporting the problem and having a service technician respond to the site of the gate operator can take hours or sometimes-even days.

There have been a number of previous attempts to address the problem of security system failure, such as the Sentex diagnostic module. However, this device relies on a telephone connection to dial out and seek help. This system has a number of drawbacks including the high cost of running a telephone line from the nearest service to the gate operator (usually involving trenching and possibly cutting cement or asphalt). In addition, there are monthly telephone service charges along with any associated long distance charges that are required.

Thus, what is needed is a system and method for monitoring security gate operation and upon the occurrence of a failure providing prompt and accurate information on the failure to those responsible for maintenance of the security system. What is also needed is an economical, easy to install and operate system that can provide instantaneous notice of a system failure. A system capable of operating in remote locations and that does not rely on land bound or wire communications.

### SUMMARY

It is an objective of the present invention to provide a system for monitoring the operation of security gate system and providing a prompt warning of an actual or potential failure of that system. It is another objective to provide a failure warning system that is economical, easy to install and operate and that does not require access to a telephone line to provide the warning.

To accomplish these and other objectives of the present invention provides a security gate monitoring and failure warning system consisting of: a diagnostic module with a microcontroller that monitors operational parameters of a security gate system; the diagnostic module includes a first two-way wireless communication unit operatively connected to the microcontroller and in proximity to the microcontroller, the first two-way wireless communication unit is capable of wireless communication with a second remotely located wireless two-way communication unit upon activation by said diagnostic module; and wherein upon detection of at least one predetermined change in an operational parameters of the security system the microcontroller causes the first two-way communication unit to send a request signal to the second two-way communication unit.

In a further aspect of the present invention, the diagnostic module includes a separate power supply which is immune to any power disruption that may affect a power supply of the security system.

In yet another aspect of the present invention, two-way communication can be established between the first communication unit and the second communication unit to allow a technician or other individual to query said microcontroller as to the status of various operational parameters of the security system.

### BRIEF DESCRIPTION OF THE DRAWINGS

The invention will be better understood by an examination of the following description, together with the accompanying drawings, in which:

FIG. 1 is a schematic block diagram of the functional components of the system;

FIG. 2 is a perspective view of a typical security gate setup;

FIG. 3 is a block diagram of various sensors that work with the diagnostic module;

FIG. 4 is a block diagram of one version of the microcontroller; and

FIG. 5 is a flow chart of a subroutine that the microcontroller would run.

### DETAILED DESCRIPTION OF THE PREFERRED EMBODIMENT

As noted above, the present invention is a diagnostic module that monitors the operational parameters of a security gate system. When a problem arises with the operation of the security gate system the problem will generally cause an identifiable variation in one or more of the operational parameters of the security gate system. When the diagnostic module of the present invention senses a change in the operational parameters beyond preset values it broadcasts a signal for help. The preset value or values of each of the operational parameters would be determined by the anticipated value of that parameter at the time of a failure of the system.

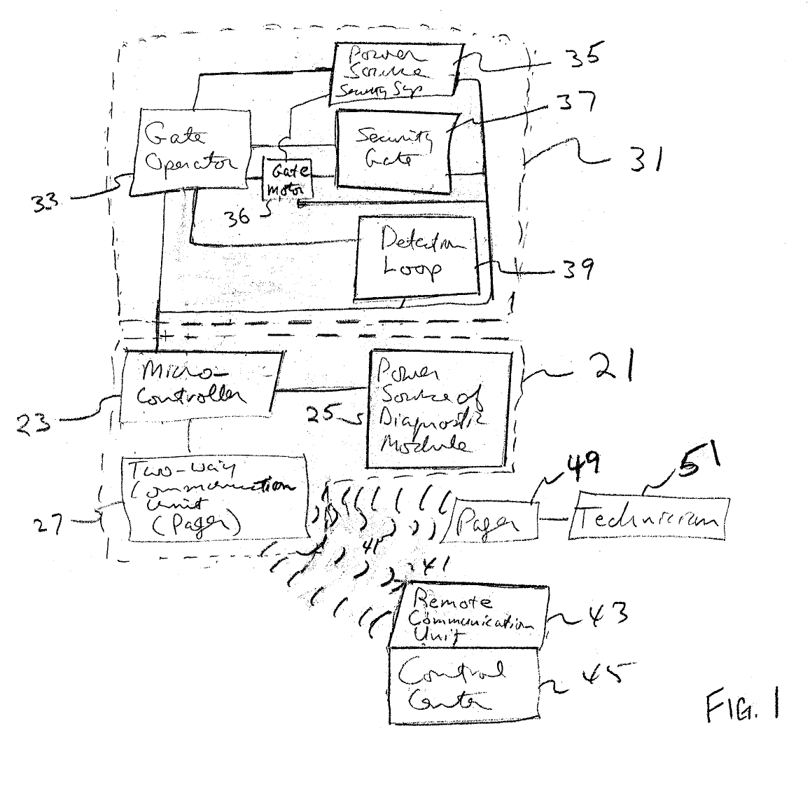

FIG. 1, a schematic block diagram, provides a view of the invention, the diagnostic module 21. Diagnostic module 21 in its preferred embodiment consists of a microcontroller 23, independent power source 25 and a two-way wireless communication unit 27. The typical security gate system 31 that the diagnostic module works with consists of a gate operator 33, power source 35, security gate 37 and detection loop 39. The system also includes a gate motor 36 to open and close the gate. Diagnostic module 21 continuously monitors the security gate system 31 and as noted above, upon detection of a problem, diagnostic module 21 sends a coded signal 41 to a remote communication unit 43 located at a control center 45. At the same time or alternatively signal 41 from the communication unit of the diagnostic module is received by pager 49 of a technician 51. Thus, as soon as the security system 31 malfunctions causing one or more of the operational parameters to exceed preset values an appropriate notice in the form a wireless transmission is sent by diagnostic module 21 to those responsible for maintenance and operation of the system.

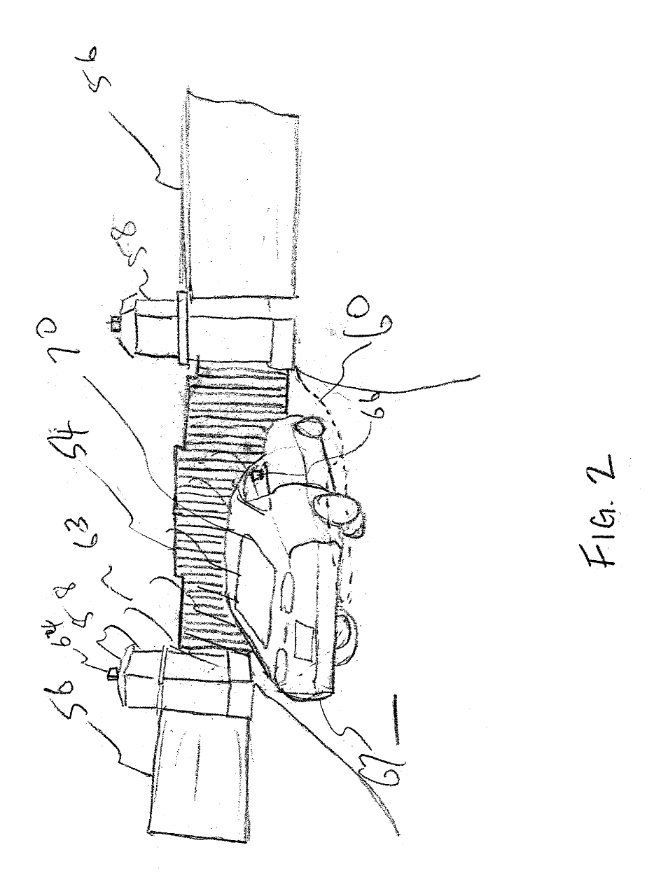

The typical security gate system as depicted in FIG. 2 may be at a remote location without any human attendant to monitor and control its operation. FIG. 2 is a perspective view of a typical remotely located security system that consists of a moveable security gate 54 and barrier 56. The security system would also include a gate operator, perhaps in an enclosure Located in one of the posts 58, a gate motor and related mechanism for opening the gate not shown. Additionally, the system might also include a vehicle detection loop 60 imbedded in the pavement. Although all of the components are not shown in FIG. 2 it is welt known in the art that with this type of security gate protecting a Limited access area when a vehicle 67 arrives at the gate 54 the gate operator detects it presence with the loop detector 60, then broadcasts a signal 63 on its own communication unit 64. This signal 63 in turn activates a transponder 66 in the vehicle 67. Transponder unit 66 in turn broadcasts its own unique signal 70 that contains the necessary code which when recognized by the gate operator prompts it to open gate 54 and allow vehicle 67 to have access to the restricted area. Once vehicle 67 passes through the entry gate the gate operator determines when vehicle 67 is no longer present with loop detector 60 and a companion one on the other side of the gate not shown. Thus, the gate operator knows when to close the gate. This example describes only one of many very basic systems that should be familiar to anyone of ordinary skill in the art. However, the described system should aid those of ordinary skill in the art to better understand the following description.

Security systems such as that described above are typically exposed to the elements since they are generally outdoors. Small animals or large insects can crawl into and interfere with the functioning of the system. Likewise, adolescents or other individuals may interfere with the system's operation or vandalize it. The system may also malfunction due to accidents caused by a vehicle inadvertently hitting part of the system when passing through the gate and thereby causing damage to various parts of the system. Other unknown influences may also cause the system to malfunction. Since the system is at a remote location or does not have a human attendant it may take sometime before knowledge of the problem reaches those responsible.

As previously noted the system of the present invention includes various sensors that monitor the operational parameters of the system. Various sensors will be monitoring the electrical components of the system to verify the current and voltage of the system are within normal operational parameters. Additionally, other sensors will monitor the temperature of the various components of the system, location and mobility of moving parts as well as the ambient air temperature. Any number of standard sensors can be used to monitor these aspects of the security gate system.

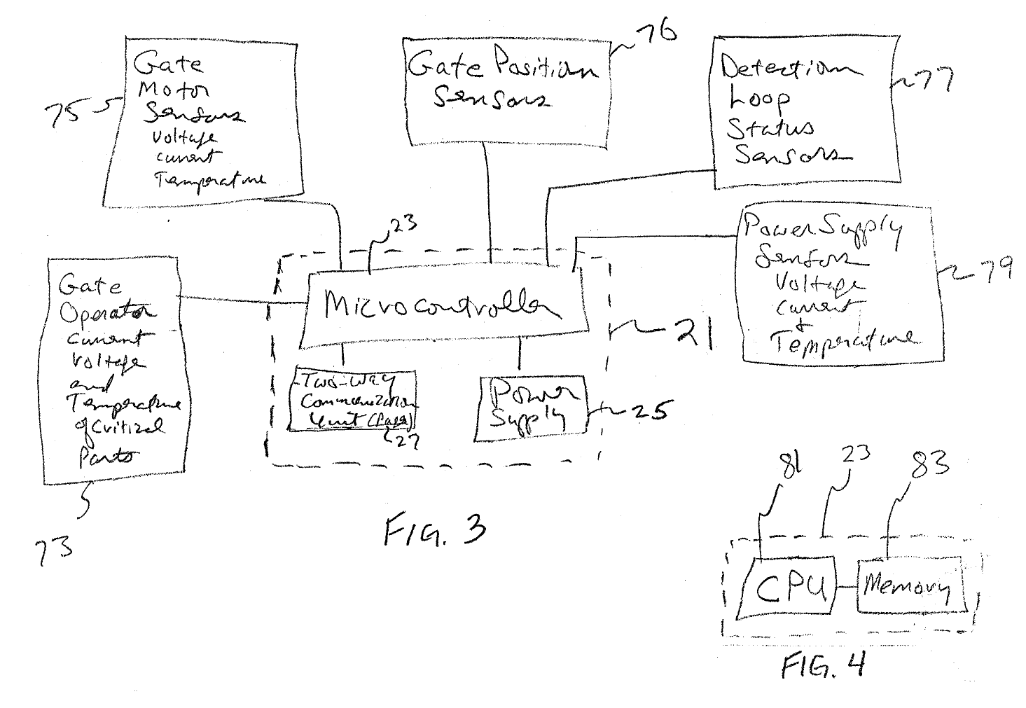

A wide variety of sensors could be used with microcontroller 23 of the diagnostic module 21 to monitor the parameters of operation of the security system. FIG. 3 depicts, without limitation, some of the types and functions of various sensors that can be employed to monitor the operation of the security system. Sensors of the gate operator 73 would monitor current, voltage or temperature of various parts of the gate operator. Sensors of the gate motor 75 would monitor current, voltage and temperature at various critical points. Position sensors 76 would monitor the location of the gate with respect to the open and closed position. Status sensors 77 of the detection loop would provide critical information on the operability of the loops and whether they are functioning within normal parameters. Power supply sensors 79 would monitor the voltage, current and temperature of the security gate power supply.

A detailed discussion of the type and location of the sensors will not be provided since those of ordinary skill in the art will know the type of sensors that would be necessary and the proper positioning of them. Likewise, a detailed description of the various parts of the security system including the gate operator has not been provided since those of ordinary skill in the art upon reading and understanding the description contained in this specification will readily understand how such systems are typically constructed and operate.

At the heart of the present system is the microcontroller, which in effect is a small programmable computer. In its most basic form microcontroller 23 has a cpu 81 (FIG. 4) and a memory 83. Naturally, microcontroller 23 can be designed as a much more sophisticated computer and the same results achieved. In the preferred embodiment the two-way communication unit 27 is a standard two-way pager such as those made and sold by Motorola or similar devices made by other companies. Using such a radio transmission device adds significant flexibility to the system in that a technician responsible for maintenance of the subject security system can be immediately notified of a problem with the system in real time. Additionally, since the pager system allows for two-way communication, the technician will be able to query microcontroller 23 regarding the status of various operational parameters of the system and, in fact in many instances, be able to diagnose precisely what type of failure or failures have occurred before arriving at the location of the security system. This will allow much quicker and more effective responses to repair the problem. Since a two-way communication system is used that relies on a wireless electromagnetic frequency transmission the diagnostic module does not have to connect to a standard telephone or other type of wire transmission system. Thus, the installation and service fees typical of such transmission line systems are avoided. Installation of the overall system is thereby simplified and made that much more cost effective. The digging of trenches or cutting of pavement to lay connecting lines is avoided.

The diagnostic module of the present invention also includes its own independent power supply 25, FIG. 3. By providing the diagnostic module with its own power supply failures or problems with the security system's power supply will not hinder or prevent it from timely warning of a system failure and being queried as to the source of the problem. Since the power supply 25 will only power microcontroller 23 and two-way communication device 27 a small compact and durable power supply will suffice. This would allow the use of batteries or similar independent power systems. The diagnostic module could also monitor its own power supply 25 and send the appropriate message when it appears its power supply 25 is running low or experiencing some other type of problem.

As previously noted the microcontroller will monitor the various operational parameters of the security system and when it detects that one or more of those parameters is equal to or more than the preset operational parameters it wilt generate a signal with pager 27. This initial signal upon receipt by a pager 49 (FIG. 1) carried by a technician 51 and/or by a remote communication unit 43 attached to central control unit 45 allow technician 51 or a person at central control unit 45 to communicate by various preprogrammed codes with diagnostic module 21, obtain additional information about the various operational parameters of the systems and perhaps determine the cause of the failure. Naturally, communication can only be initiated and maintained between unit 27 and the remote unit 43 or pager 49 when they receive the proper security codes.

This will avoid an unauthorized third party from obtaining access to the diagnostic module of the security system or to the central control unit 45. Additionally, all communication in a preferred embodiment of the invention could be suitably encrypted to add further security safeguards to the system.

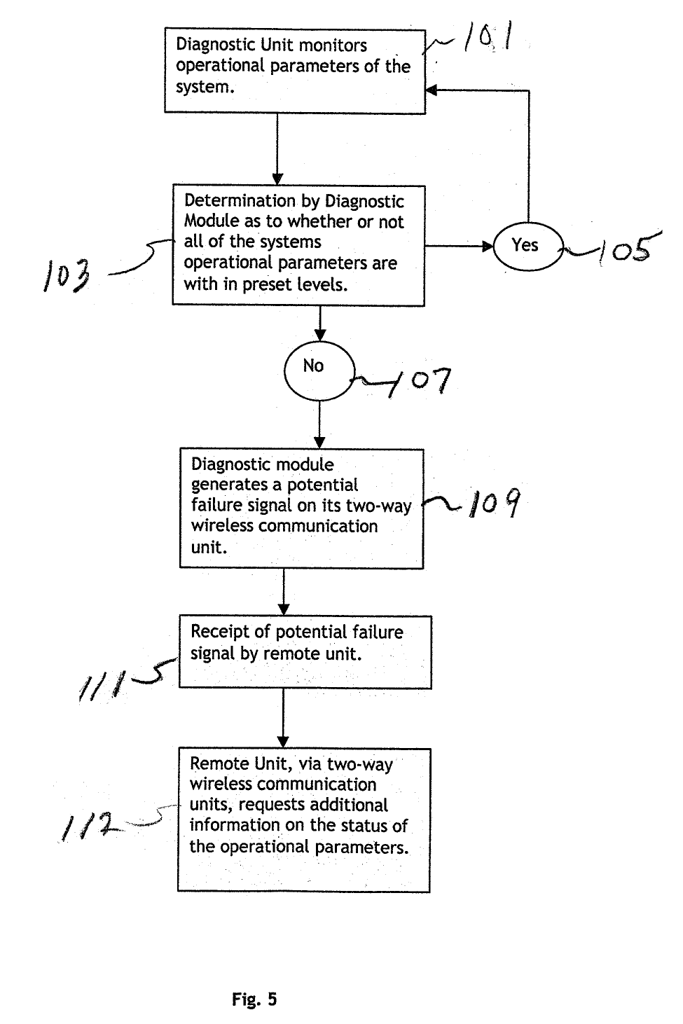

FIG. 5 provides an example of one subroutine function the system would perform during standard operation. The diagnostic module would periodically monitor all of the operational parameters of the system 101. A monitoring cycle could last for a second or less. During each cycle the diagnostic module, specifically the microcontroller, would be determining if all of the operational parameters are within acceptable levels 103. A table of preset operational parameters would be contained in a lookup table in memory 83. If all of the operational parameters are within the preset norm 105 the system then continues on the loop of monitoring the operational parameters 101 and determining if they are within preset norms 103. When the system determines that one or more of the operational parameters are not within preset norms 107 it then generates a potential failure signal 109 with its wireless two-way communication system. Once the remote unit or control unit receives this signal 111 then the technician or operator of the control unit can question the diagnostic unit 112 regarding various operational parameters. For example, during operation assume the gate becomes jammed open for some reason. This would result in the diagnostic unit sending a distress signal since one or more of the operational parameters or beyond preset values i.e. the gate position sensor would indicate the gate has not returned to the closed position. Once the signal is received by the technician's pager he can query the diagnostic unit via the communication link and determine the gate is open, that the gate motor when it is directed to close the gate is experiencing a mechanical overload. The technician would also be able to determine that all of the other operational parameters are operating within normal values. Thus, the technician can make a preliminary determination that the failure appears to be caused by the gate being jammed open.

While the invention has been particularly shown and described with reference to a preferred embodiment thereof, it will be understood by those skilled in the art that various changes in form and detail may be made to it without departing from the spirit and scope of the invention.

We claim:

1. A system for monitoring the operation of a security system comprising:
a. a security system for controlling access to a secure area said system including at least one movable barrier operated by a barrier controller;
b. a diagnostic module operating in conjunction with the security system wherein said diagnostic module includes a microcontroller which monitors various operational parameters of the security system;
c. said diagnostic module includes a communication unit operating in conjunction with said microcontroller and capable of two-way wireless communications;
d. a remote monitor capable of two way wireless communication with said communication unit of said diagnostic module; and
e. wherein said micro controller monitors the operational parameters of the security system and when any of said operational parameters of the system reach a pre-designated level said diagnostic module communicates such over communication unit to said remote monitor.

2. The system of claim 1 wherein said remote monitor can by communicating with said diagnostic module through said communication unit query said microcontroller as to the status of various operational parameters of the security system.

3. The system of claim 1 wherein said diagnostic module is functionally independent of the security system.

4. The system of claim 3 wherein said diagnostic module has its own power supply.

5. The system of claim 1 wherein said diagnostic module has its own power supply.

6. The system of claim 2 wherein said communication unit and remote monitor are two-way pagers.

7. The system of claim 6 wherein a service technician with said remote monitor communicates with said diagnostic unit.

8. The system of claim 1 wherein said communication unit and remote monitor are two-way pagers.

9. The system of claim 8 wherein a service technician with said remote monitor communicates with said diagnostic unit.

10. A security gate monitoring and failure warning system comprising:
a diagnostic module with a microcontroller that monitors operational parameters of a security gate system;

15. The system of claim 10 wherein a service technician with said second communication unit communicates with said diagnostic unit through said first communication unit.
